(19) United States
(12) Patent Application Publication
(10) Pub. No.: US 2018/0217079 A1
(43) Pub. Date: Aug. 2, 2018

(54) DETERMINING AN ANALYTE CONCENTRATION OF A PHYSIOLOGICAL FLUID HAVING AN INTERFERENT

(71) Applicant: Cilag GmbH International, Zug (CH)

(72) Inventor: Stephen A. Mackintosh, Inverness (GB)

(21) Appl. No.: 15/420,129

(22) Filed: Jan. 31, 2017

(51) Int. Cl. G01N 27/27; G01N 27/327

(52) U.S. Cl. CPC G01N 27/27; G01N 27/3273; G01N 27/3272

(57) ABSTRACT

Systems and methods for determining a concentration of an analyte in a physiological fluid are presented. A test voltage is applied between a first electrode and the second electrode of a biosensor, in which the first electrode includes a reagent and the second electrode is uncoated with the reagent. The reagent is selected for a reaction with the analyte, but not with the interferent. First and second current values are measured at the first and second electrodes during first and second time periods after application of the test voltage, respectively. First and second current parameters are determined by taking the sums of the current values and subtracting factors dependent on at least one of the current values. The analyte concentration is determined as a function of a ratio of the first current parameter and the second current parameter.

### TECHNICAL FIELD

This application is generally directed to the field of analyte measurement systems and more specifically to a system and related method for compensating an analyte measurement, for example, in an electrochemical cell, from at least one interferent.

### BACKGROUND

Analyte detection in physiological fluids, e.g., blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, and the like. In response to this growing importance of analyte detection, a variety of analyte detection protocols and devices for both clinical and home use have been developed.

One method that is employed for analyte detection is that using an electrochemical cell. In such methods, an aqueous liquid sample is placed into a sample-receiving chamber in the electrochemical cell defined by two electrodes, e.g., a counter and working electrode arranged either in a coplanar or facing orientation. The analyte is allowed to react with a redox reagent to form an oxidizable (or reducible) substance in an amount corresponding to the analyte concentration when a potential is applied to the cell. The quantity of the oxidizable (or reducible) substance present is then estimated electrochemically and related to the amount of analyte present in the initial sample.

Such systems are susceptible to various modes of inefficiency and/or error. For example, various blood glucose measurement systems, such as those manufactured by LifeScan Inc., and marketed as One-Touch Verio (“Verio”), is used to measure glucose concentrations. When conducting measurements using the electrochemical cell, the results can be affected by various factors. To that end, corrections for the effects of hematocrit and other interfering reducing agents from a blood sample of a subject, such as uric acid, are desired. For example, interferents such as reducing agents in the form of uric acid may affect the results of the method, leading to a potential hematocrit dependence. As an example, an electroactive species such as uric acid or ferrocyanide could be uniformly distributed in an electrochemical cell. Analyte concentration measurements taken immediately after switching test potentials can be in a regime in which the concentration gradient of analyte reaction products has not yet moved out sufficiently into the electrochemical cell such that it is influenced by the gradient developing at the opposite electrode. In such a case, the agent may interfere with the analyte concentration measurement.

### BRIEF DESCRIPTION

In one embodiment, disclosed herein is a method for determining a concentration of an analyte in a physiological fluid with a biosensor having a first electrode and a second electrode. The physiological fluid includes the analyte and an interferent. A test voltage is applied between the first electrode and the second electrode of the biosensor, in which only the first electrode includes a coated reagent. The reagent is selected for a reaction with the analyte, but not with the interferent. First current values are measured at the second electrode during a first time period after application of the test voltage. The first time period is an early stage of the reaction of the reagent with the analyte. Second current values are measured at the first uncoated electrode during a second time period after application of the voltage signal. The second time period is a later stage of the reaction of the reagent with the analyte. The analyte concentration is calculated. A first current parameter is determined by taking the sum of the first current values and subtracting a first factor dependent on at least one of the first current values. A second current parameter is determined by taking the sum of the second current values and subtracting a second factor dependent on the at least one of the first current values. The analyte concentration is determined as a function of a ratio of the first current parameter and the second current parameter.

In another embodiment, a glucose measurement system is presented. The glucose measurement system includes a biosensor and a test meter. The biosensor has a first electrode and a second electrode, e.g., defining an electrochemical cell. The first electrode includes a reagent and the second electrode is uncoated with the reagent. The reagent is selected for a reaction with glucose, but not with an interferent. The test meter includes a strip port connector configured to connect to the first electrode and the second electrode and a microcontroller programmed to determine a glucose concentration. A test voltage is applied between the first electrode and the second electrode of the biosensor. First current values are measured at the second electrode during a first time period after application of the voltage signal. The first time period being an early stage of the reaction of the reagent with the glucose. Second current values are measured at the first uncoated electrode during a second time period after application of the voltage signal. The second time period is a later stage of the reaction of the reagent with the analyte.

The analyte concentration may be calculated using an equation of the form

$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$

in which: G is the analyte concentration, iᵣ is the sum of the first current values, iₗ is the sum of the second current values, i(δ) is one of the first current values, i_{2corr} is a function of iᵣ and at least some of the first and second current values, and u, v, a, and z_{gr} are predetermined coefficients.

The above embodiments are intended to be merely examples. It will be readily apparent from the following discussion that other embodiments are within the scope of the disclosed subject matter.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the disclosed subject matter encompasses other embodiments as well. The drawings are not necessarily to scale, emphasis generally being placed upon illustrating the features of certain embodiments of the invention. In the drawings, like numerals are used to indicate like parts throughout the various views.

FIG. 1A illustrates an exemplary blood glucose measurement meter or system;

FIG. 1B illustrates various components disposed in the meter of FIG. 1A;

FIG. 1C illustrates a perspective view of an assembled biosensor or test strip suitable for use in the system and methods disclosed herein;

FIG. 1D illustrates an exploded perspective view of an unassembled test strip suitable for use in the system and methods disclosed herein;

FIG. 1E illustrates an expanded perspective view of a proximal portion of the test strip suitable for use in the system and methods disclosed herein;

FIG. 2 illustrates a bottom plan view of one embodiment of a test strip disclosed herein;

FIG. 3 illustrates a side elevational view of the test strip of FIG. 2;

FIG. 4A illustrates a top plan view of the test strip of FIG. 3;

FIG. 4B illustrates a partial side view of a proximal portion of the test strip of FIG. 4A;

FIG. 5 illustrates a simplified schematic showing a test meter electrically interfacing with portions of a test strip disclosed herein;

FIG. 6 illustrates generally the steps involved in one embodiment of determining a glucose measurement;

FIG. 7A is an example of a tri-pulse potential waveform applied by the test meter of FIG. 5 to the working and counter electrodes for prescribed time intervals;

FIG. 7B depicts a first and second current transient generated when testing a physiological sample; and

FIG. 8A-8D depict an experimental validation of the benefits of the present technique over conventional techniques.

### DETAILED DESCRIPTION

The following Detailed Description should be read with reference to the drawings, in which like elements in different drawings are identically numbered. The drawings, which are not necessarily to scale, depict selected embodiments and are not intended to limit the scope of the invention. The Detailed Description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject techniques in a human patient represents a preferred embodiment.

The present disclosure relates, in part, to analyte measurement technology, such as methods, systems and devices for measuring concentrations of analytes in a physiological fluid notwithstanding the presence of interferents in the physiological fluid.

By way of explanation, an analyte measurement system may seek to determine the concentration of a specific analyte in a physiological fluid. But other chemical compounds may be present in the physiological fluid. For example, uric acid may be present in the blood of the patient, and the concentration of the uric acid may vary. In some cases, the chemical compound may be an interferent which interferes with the measurement of the analyte. In another example, a physical property of the physiological fluid may itself interfere with the measurement of the analyte. Such physical properties may include temperature, hematocrit and viscosity, among others. In such cases, the accuracy of the analyte measurement system may be compromised.

One way of overcoming these limitations is to correct for the interfering chemical compounds or physical characteristics. In the case of an electrochemical test strip used with an analyte meter, understanding the timing of the chemical reactions can assist in developing new techniques for correcting for these problems and obtaining more accurate analyte measurements. For example, a biosensor may include a reagent that is capable of reacting with the analyte but not with the interferent. By arranging for some electrodes to be coated with a reagent but other electrodes to be uncoated, and by measuring carefully the current response of the physiological fluid upon application of test voltages, Applicant has discovered that the analytic concentrations can be corrected for the interferent, as will be explained in further detail below.

Generally stated, in one aspect, disclosed herein is a method for determining a concentration of an analyte in a physiological fluid with a biosensor having a first electrode and a second electrode. The physiological fluid includes the analyte and an interferent. A voltage is applied between the first electrode and the second electrode of the biosensor, where the first electrode includes a reagent and the second electrode is uncoated with the reagent. The reagent is selected for a reaction with the analyte but not with the interferent. First current values are measured at the second electrode during a first time period after application of the voltage signal. The first time period is an early stage of the reaction of the reagent with the analyte. Second current values are measured at the first uncoated electrode during a second time period after application of the voltage signal. The second time period is a later stage of the reaction of the reagent with the analyte. The analyte concentration is calculated. A first current parameter is determined by taking the sum of the first current values and subtracting a first factor dependent on at least one of the first current values. A second current parameter is determined by taking the sum of the second current values and subtracting a second factor dependent on the at least one of the first current values. The analyte concentration is determined as a function of a ratio of the first current parameter and the second current parameter.

In one embodiment, calculating the analyte concentration includes using an equation of the form

$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$

where: G is the analyte concentration; iᵣ is the sum of the first current values; iₗ is the sum of the second current values; i(δ) is one of the first current values; i_{2corr} is a function of iᵣ and at least some of the first and second current values; and u, v, a, and z_{gr} are predetermined coefficients. In another embodiment, i_{2corr} is determined by an equation of the form

$${i}_{2 corr} = \frac{\vert i ( 4.1 s ) \vert + c \vert i ( 5 s ) \vert - d \vert i ( 1.1 s ) \vert}{\vert i ( 4.1 s ) \vert + c \vert i ( 5 s ) \vert} \cdot {i}_{r} .$$

In a further embodiment, the predetermined coefficients are determined using a control fluid having a controlled concentration of the analyte and the interferent, e.g., by using a number of biosensors and a control fluid which is prepared in a laboratory.

In one example, the first time period is between about 1.4 seconds and 4 seconds after initiating the method. In another example, the second time period begins about 4.1 seconds after initiating the method. In another example, the second time period is between about 4.4 seconds and 5 seconds after initiating the method. In a further example, at least one steady state current value is measured during a third time period after application of the voltage signal. In such a case, the third time period may begin about 5 seconds after initiating the method.

In one specific implementation, application of the voltage may be delayed for a time interval after the physiological fluid contacts the biosensor, e.g., to allow the reagent to react with the analyte and for reaction products to begin to form in the physiological fluid. In another specific example, the analyte can be or include glucose and the interferent can be or include uric acid. In a further specific example, the interferent can include first and second interferent species.

Depending upon the implementation, the first and second voltages may have opposite polarities, may be alternating or direct current, or some combination thereof.

In another aspect, a glucose measurement system is presented. The glucose measurement system includes a biosensor and a glucose meter. The biosensor has a first electrode and a second electrode. The first electrode includes a reagent and the second electrode is uncoated with the reagent. The reagent is selected for a reaction with glucose but not with an interferent. The glucose meter includes a strip port connector configured to connect to the first electrode and the second electrode and a microcontroller programmed to determine a glucose concentration. A voltage is applied between the first electrode and the second electrode of the test strip. First current values are measured at the second electrode during a first time period after application of the voltage signal. The first time period is an early stage of the reaction of the reagent with the glucose. Second current values are measured at the first uncoated electrode during a second time period after application of the voltage signal. The second time period is a later stage of the reaction of the reagent with the analyte. The analyte concentration is calculated using an equation of the form

$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$

in which: G is the analyte concentration, iᵣ is the sum of the first current values, iₗ is the sum of the second current values, i(δ) is one of the first current values, i_{2corr} is a function of iᵣ and at least some of the first and second current values, and u, v, a, and z_{gr} are predetermined coefficients.

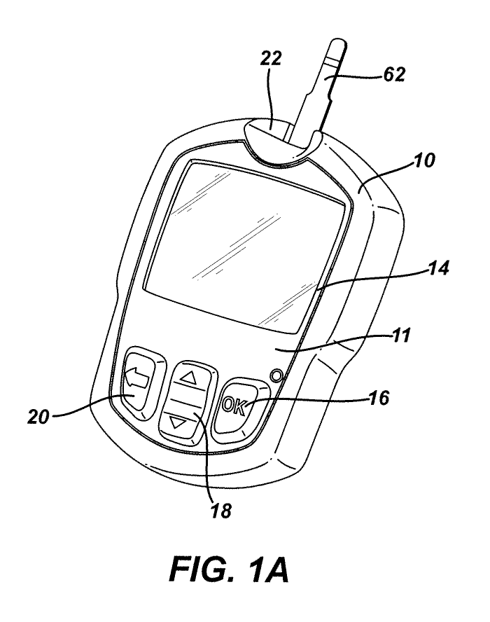

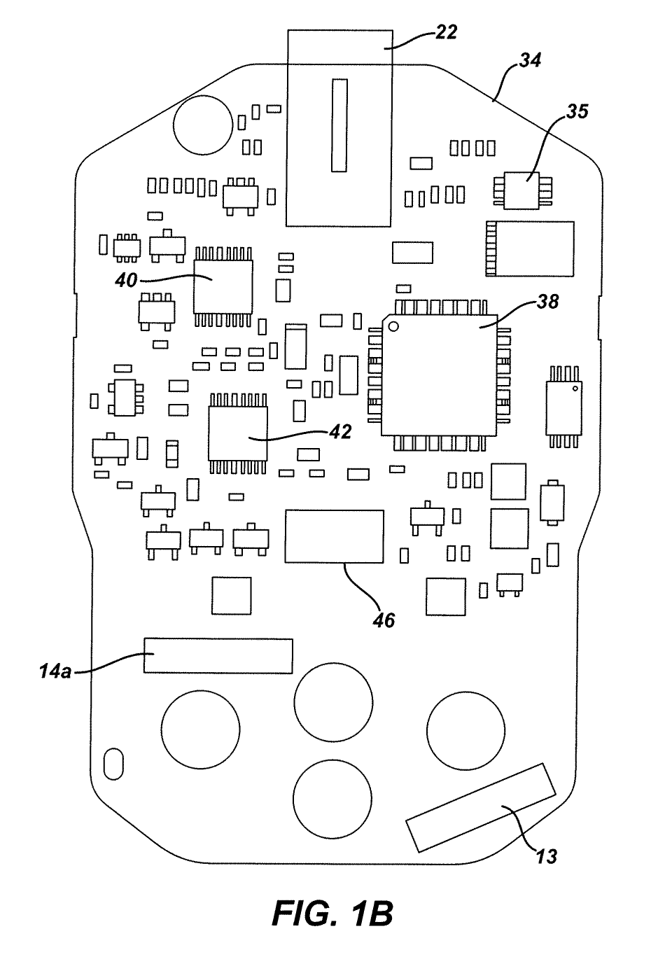

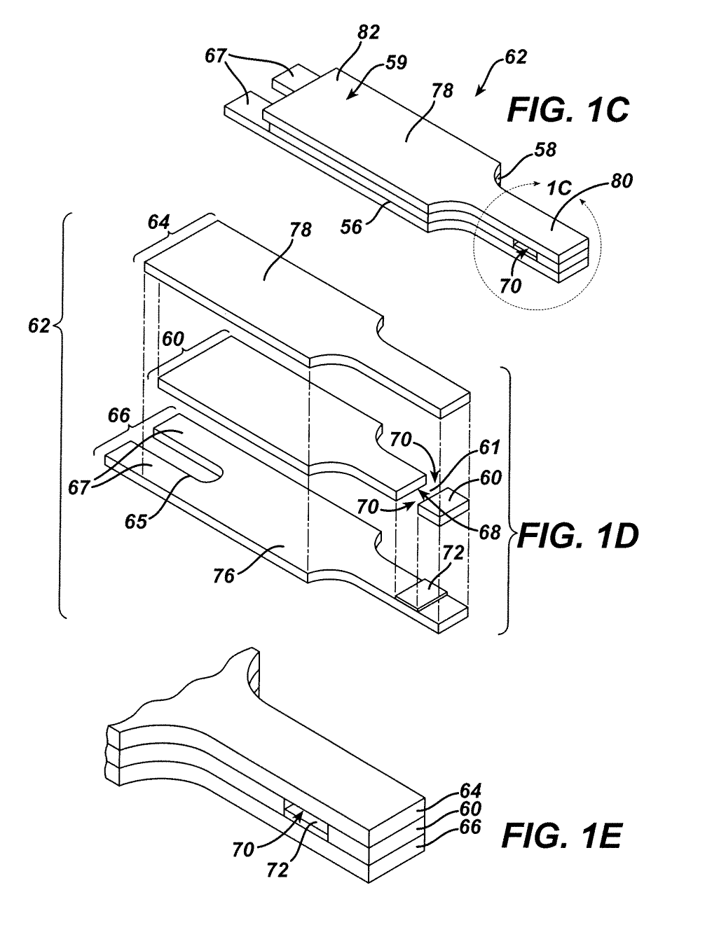

Specific working examples will next be described with respect to FIGS. 1A-7B. FIG. 1A illustrates a diabetes management system that includes a meter 10 and a biosensor in the form of a glucose test strip 62. Note that the meter (synonymously referred to herein as a “meter unit”) may also be referred to throughout as an analyte measurement and management unit, a glucose meter, a test meter, and an analyte measurement device. In an embodiment, the meter unit may be combined with an insulin delivery device, an additional analyte testing device, and a drug delivery device. The meter unit may be connected to a remote computer or remote server via a cable or a suitable wireless technology such as, for example, GSM, CDMA, BlueTooth, WiFi and the like.

Referring back to FIG. 1A, the glucose meter or meter unit 10 may include a housing 11 that retains a plurality of components (discussed infra). A series of user interface buttons (16, 18, and 20) are disposed on one face of the housing 11 in relation to a display 14, and in which the housing 11 further includes a defined strip port opening 22 configured for receiving a biosensor, such as test strip 62. The user interface buttons (16, 18, and 20) may be configured to allow the entry of data, navigation of menus, and execution of commands. User interface button 18 may be in the form of a two way toggle switch. Data may include values representative of analyte concentration, as well as other information which is related to the everyday lifestyle of an individual. Information, which is related to the everyday lifestyle, may include food intake, medication use, occurrence of health check-ups, and general health condition and exercise levels of an individual. The electronic components of the meter 10 may be disposed on a circuit board 34 that is disposed within the housing 11.

FIG. 1B illustrates (in simplified schematic form) the electronic components disposed on a top surface of the circuit board 34. On the top surface, the electronic components include a strip port connector 22, an operational amplifier circuit 35, a microcontroller 38, a display connector 14a, a non-volatile memory 40, a clock 42, and a first wireless module 46. On the bottom surface, the electronic components may include a battery connector (not shown) and a data port 13. Microcontroller 38 may be electrically connected to the strip port connector 22, operational amplifier circuit 35, first wireless module 46, the display 14, non-volatile memory 40, clock 42, battery, data port 13, and the user interface buttons (16, 18, and 20).

Operational amplifier circuit 35 may include two or more operational amplifiers configured to provide a portion of the potentiostat function and the current measurement function. The potentiostat function may refer to the application of a test voltage between at least two electrodes of a test strip. The current function may refer to the measurement of a test current resulting from the applied test voltage. The current measurement may be performed with a current-to-voltage converter. Microcontroller 38 may be in the form of a mixed signal microprocessor (MSP) such as, for example, the Texas Instruments (TI) MSP 430. The MSP 430 may be configured to also perform a portion of the potentiostat function and the current measurement function. In addition, the MSP 430 may also include volatile and non-volatile memory. In another embodiment, many of the electronic components may be integrated with the microcontroller in the form of an application specific integrated circuit (ASIC).

Strip port connector 22 may be configured to form an electrical connection to the test strip. Display connector 14a may be configured to attach to the display 14. Display 14 may be in the form of a liquid crystal display for reporting measured glucose levels, and for facilitating entry of lifestyle related information. Display 14 may optionally include a backlight. Data port 13 may accept a suitable connector attached to a connecting lead, thereby allowing glucose meter 10 to be linked to an external device such as a personal computer. Data port 13 may be any port that allows for transmission of data such as, for example, a serial, USB, or a parallel port. Clock 42 may be configured to keep current time related to the geographic region in which the user is located and also for measuring time. The meter unit may be configured to be electrically connected to a power supply such as, for example, a battery.

FIGS. 1C-1E, 2, 3, and 4B show various views of an exemplary test strip 62 suitable for use with the methods and systems described herein. In an exemplary embodiment, a test strip 62 is provided which includes an elongate body extending from a distal end 80 to a proximal end 82, and having lateral edges 56, 58, as illustrated in FIG. 1C. As shown in FIG. 1D, the test strip 62 also includes a first electrode layer 66, a second electrode layer 64, and a spacer 60 sandwiched in between the two electrode layers 64 and 66. The first electrode layer 66 may include a first electrode 166, a first connection track 76, and a first contact pad 67, where the first connection track 76 electrically connects the first electrode 166 to the first contact pad 67, as shown in FIGS. 1D and 4B. Note that the first electrode 166 is a portion of the first electrode layer 66 that is immediately underneath the reagent layer 72, as indicated by FIGS. 1D and 4B. Similarly, the second electrode layer 64 may include a second electrode 164, a second connection track 78, and a second contact pad 63, where the second connection track 78 electrically connects the second electrode 164 with the second contact pad 63, as shown in FIGS. 1D, 2, and 4B. Note that the second electrode 164 is a portion of the second electrode layer 64 that is above the reagent layer 72, as indicated by FIG. 4B.

As shown, the sample-receiving chamber 61 is defined by the first electrode 166, the second electrode 164, and the spacer 60 near the distal end 80 of the test strip 62, as shown in FIGS. 1D and 4B. The first electrode 166 and the second electrode 164 may define the bottom and the top of sample-receiving chamber 61, respectively, as illustrated in FIG. 4B. A cutout area 68 of the spacer 60 may define the sidewalls of the sample-receiving chamber 61, as illustrated in FIG. 4B. In one aspect, the sample-receiving chamber 61 may include ports 70 that provide a sample inlet and/or a vent, as shown in FIGS. 1C to 1E. For example, one of the ports may allow a fluid sample to ingress and the other port may allow air to egress.

In an exemplary embodiment, the sample-receiving chamber 61 (or test cell or test chamber) may have a small volume. For example, the chamber 61 may have a volume in the range of from about 0.1 microliters to about 5 microliters, about 0.2 microliters to about 3 microliters, or, preferably, about 0.3 microliters to about 1 microliter. To provide the small sample volume, the cutout 68 may have an area ranging from about 0.01 cm² to about 0.2 cm², about 0.02 cm² to about 0.15 cm², or, preferably, about 0.03 cm² to about 0.08 cm². In addition, first electrode 166 and second electrode 164 may be spaced apart in the range of about 1 micron to about 500 microns, preferably between about 10 microns and about 400 microns, and more preferably between about 40 microns and about 200 microns. The relatively close spacing of the electrodes may also allow redox cycling to occur, where oxidized mediator generated at the first electrode 166, may diffuse to the second electrode 164 to become reduced, and subsequently diffuse back to first electrode 66 to become oxidized again. Those skilled in the art will appreciate that various such volumes, areas, and/or spacing of electrodes is within the spirit and scope of the present disclosure.

In one embodiment, the first electrode layer 66 and the second electrode layer 64 may be a conductive material formed from materials such as gold, palladium, carbon, silver, platinum, tin oxide, iridium, indium, or combinations thereof (e.g., indium doped tin oxide). In addition, the electrodes may be formed by disposing a conductive material onto an insulating sheet (not shown) by a sputtering, electroless plating, or a screen-printing process. In one exemplary embodiment, the first electrode layer 66 and the second electrode layer 64 may be made from sputtered palladium and sputtered gold, respectively. Suitable materials that may be employed as spacer 60 include a variety of insulating materials, such as, for example, plastics (e.g., PET, PETG, polyimide, polycarbonate, polystyrene), silicon, ceramic, glass, adhesives, and combinations thereof. In one embodiment, the spacer 60 may be in the form of a double sided adhesive coated on opposing sides of a polyester sheet where the adhesive may be pressure sensitive or heat activated. It should be noted that various other materials for the first electrode layer 66, the second electrode layer 64, and/or the spacer 60 are within the spirit and scope of the present disclosure.

Either the first electrode 166 or the second electrode 164 may perform the function of a working electrode depending on the magnitude and/or polarity of the applied test voltage. The working electrode may measure a limiting test current that is proportional to the reduced mediator concentration. For example, if the current limiting species is a reduced mediator (e.g., ferrocyanide), then it may be oxidized at the first electrode 166 as long as the test voltage is sufficiently greater than the redox mediator potential with respect to the second electrode 164. In such a situation, the first electrode 166 performs the function of the working electrode and the second electrode 164 performs the function of a counter/reference electrode. For purposes of this description, one may refer to a counter/reference electrode simply as a reference electrode or a counter electrode. A limiting oxidation occurs when all reduced mediator has been depleted at the working electrode surface such that the measured oxidation current is proportional to the flux of reduced mediator diffusing from the bulk solution towards the working electrode surface. The term “bulk solution” refers to a portion of the solution sufficiently far away from the working electrode where the reduced mediator is not located within a depletion zone. It should be noted that unless otherwise stated for test strip 62, all potentials applied by test meter 10 will hereinafter be stated with respect to second electrode 164.

Similarly, if the test voltage is sufficiently less than the redox mediator potential, then the reduced mediator may be oxidized at the second electrode 164 as a limiting current. In such a situation, the second electrode 164 performs the function of the working electrode and the first electrode 166 performs the function of the counter/reference electrode.

Initially, an analysis may include introducing a quantity of a fluid sample into a sample-receiving chamber 61 via a port 70. In one aspect, the port 70 and/or the sample-receiving chamber 61 may be configured such that capillary action causes the fluid sample to fill the sample-receiving chamber 61. The first electrode 166 and/or second electrode 164 may be coated with a hydrophilic reagent to promote the capillarity of the sample-receiving chamber 61. For example, thiol derivatized reagents having a hydrophilic moiety such as 2-mercaptoethane sulfonic acid may be coated onto the first electrode and/or the second electrode.

In the analysis of test strip 62 above, reagent layer 72 can include glucose dehydrogenase (GDH) based on the PQQ co-factor and ferricyanide. In another embodiment, the enzyme GDH based on the PQQ co-factor may be replaced with the enzyme GDH based on the FAD co-factor. When blood or control solution is dosed into a sample reaction chamber 61, glucose is oxidized by GDH₍ₒₓ₎ and in the process converts GDH₍ₒₓ₎ to GDH_{(red)}, as shown in the chemical transformation T.1 below. Note that GDH₍ₒₓ₎ refers to the oxidized state of GDH, and GDH_{(red)} refers to the reduced state of GDH.

D-Glucose+GDH₍ₒₓ₎→Gluconic acid+GDH_{(red)} T.1

Next, GDH_{(red)} is regenerated back to its active oxidized state by ferricyanide (i.e. oxidized mediator or Fe(CN)₆³⁻) as shown in chemical transformation T.2 below. In the process of regenerating GDH₍ₒₓ₎, ferrocyanide (i.e. reduced mediator or Fe(CN)₆⁴⁻ is generated from the reaction as shown in T.2:

GDH_{(red)}+2Fe(CN)₆³⁻→GDH₍ₒₓ₎+2Fe(CN)₆⁴⁻ T.2

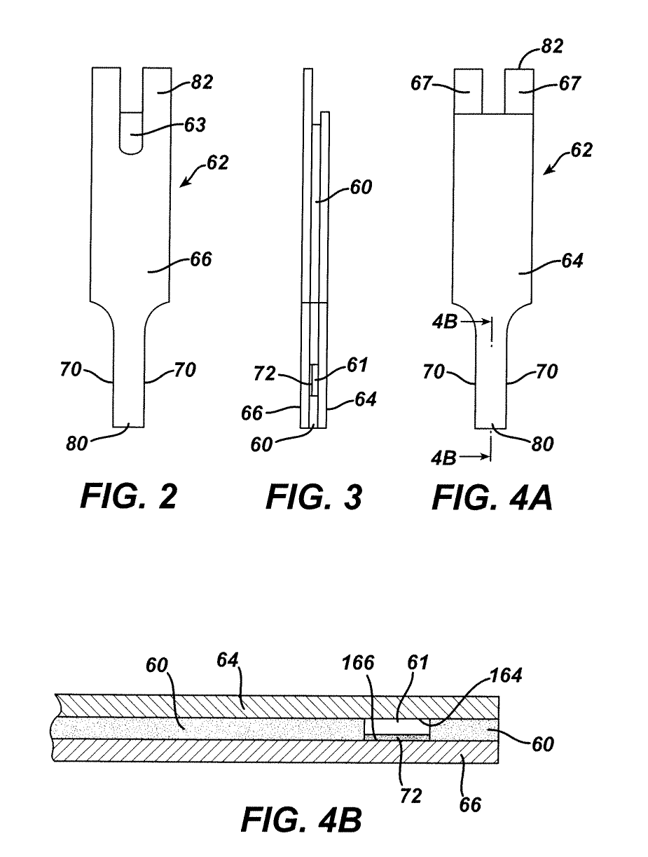

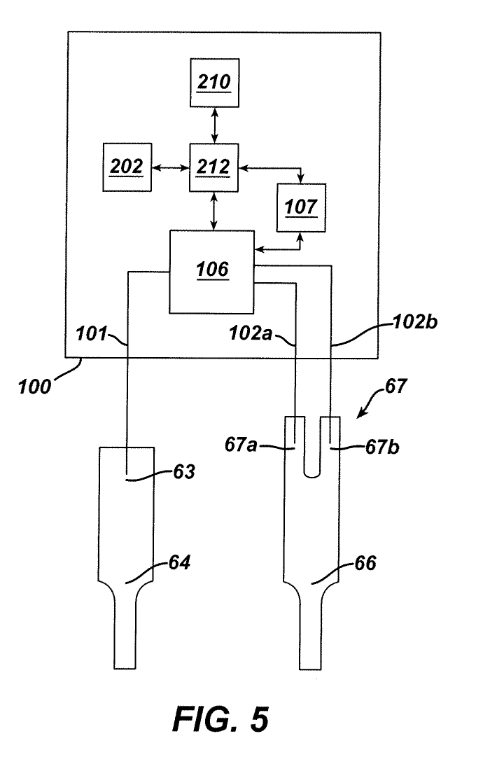

FIG. 5 provides a simplified schematic showing a test meter 100 interfacing with a first contact pad 67a, 67b and a second contact pad 63. The second contact pad 63 may be used to establish an electrical connection to the test meter through a U-shaped notch 65, as illustrated in FIG. 2. In one embodiment, the test meter 100 may include a second electrode connector 101, and a first electrode connectors (102a, 102b), a test voltage unit 106, a current measurement unit 107, a processor 212, a memory unit 210, and a visual display 202, as shown in FIG. 5. The first contact pad 67 may include two prongs denoted as 67a and 67b. In one exemplary embodiment, the first electrode connectors 102a and 102b separately connect to prongs 67a and 67b, respectively. The second electrode connector 101 may connect to second contact pad 63. The test meter 100 may measure the resistance or electrical continuity between the prongs 67a and 67b to determine whether the test strip 62 is electrically connected to the test meter 10.

In one embodiment, the test meter 100 may apply a test voltage and/or a current between the first contact pad 67 and the second contact pad 63. Once the test meter 100 recognizes that the strip 62 has been inserted, the test meter 100 turns on and initiates a fluid detection mode. In one embodiment, the fluid detection mode causes test meter 100 to apply a constant current of about 1 microampere between the first electrode 166 and the second electrode 164. Because the test strip 62 is initially dry, the test meter 10 measures a relatively large voltage. When the fluid sample bridges the gap between the first electrode 166 and the second electrode 164 during the dosing process, the test meter 100 will measure a decrease in measured voltage that is below a predetermined threshold causing test meter 10 to automatically initiate the glucose test.

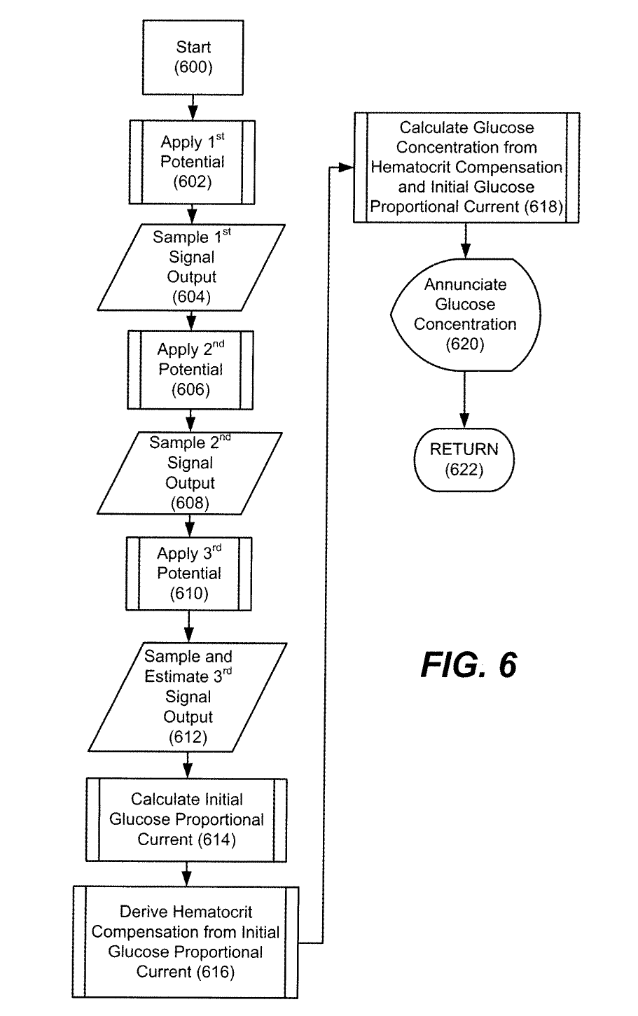

Referring to FIG. 6, a method 600 for determining an interferent-corrected analyte concentration (e.g., glucose) that uses the aforementioned meter 10 and test strip 62 embodiments will now be described. In the method, meter 10 and test strip 62 are provided. Meter 10 may include electronic circuitry that can be used to apply a plurality of voltages to the test strip 62 and to measure a current transient output resulting from an electrochemical reaction in a test chamber of the test strip 62. Meter 10 also may include a signal processor with a set of instructions for the method of determining an analyte concentration in a fluid sample as disclosed herein. In one embodiment, the analyte is blood glucose.

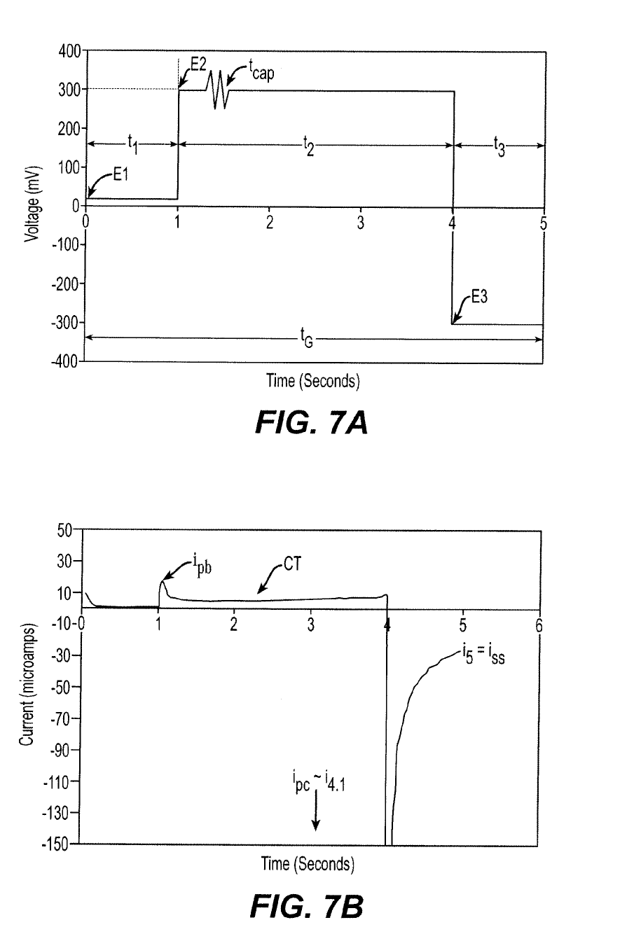

FIG. 7A is an exemplary chart of a plurality of test voltages applied to the test strip 62 for prescribed intervals. The plurality of test voltages may include a first test voltage E1 for a first time interval t₁, a second test voltage E2 for a second time interval t₂, and a third test voltage E3 for a third time interval t₃. The third voltage E3 may be different in the magnitude of the electromotive force, in polarity, or combinations of both with respect to the second test voltage E2. In the preferred embodiments, E3 may be of the same magnitude as E2 but opposite in polarity. A glucose test time interval t_{G} represents an amount of time to perform the glucose test (but not necessarily all the calculations associated with the glucose test). Glucose test time interval t_{G} may range from about 1.1 seconds to about 5 seconds. Further, as illustrated in FIG. 6A, the second test voltage E2 may include a constant (DC) test voltage component and a superimposed alternating (AC), or alternatively oscillating, test voltage component. The superimposed alternating or oscillating test voltage component may be applied for a time interval indicated by t_{cap}.

The plurality of test current values measured during any of the time intervals may be performed at a frequency ranging from about 1 measurement per microsecond to about one measurement per 100 milliseconds and preferably at about 50 milliseconds. While an embodiment using three test voltages in a serial manner is described, the glucose test may include different numbers of open-circuit and test voltages. For example, as an alternative embodiment, the glucose test could include an open-circuit for a first time interval, a second test voltage for a second time interval, and a third test voltage for a third time interval. It should be noted that the reference to “first,” “second,” and “third” are chosen for convenience and do not necessarily reflect the order in which the test voltages are applied. For instance, an embodiment may have a potential waveform where the third test voltage may be applied before the application of the first and second test voltage.

In exemplary step 600, the glucose assay is initiated by inserting a test strip 62 into the test meter 10 and by depositing a sample on the test strip 62. In exemplary step 602, the test meter 10 may apply a first test voltage E1 (e.g., approximately 20 mV in FIG. 7A) between first electrode 166 and second electrode 164 for a first time interval t₁ (e.g., 1 second in FIG. 7A). The first time interval t₁ may range from about 0.1 seconds to about 3 seconds and preferably range from about 0.2 seconds to about 2 seconds, and most preferably range from about 0.3 seconds to about 1.1 seconds.

The first time interval t₁ may be sufficiently long so that the sample-receiving chamber 61 may fully fill with sample and also so that the reagent layer 72 may at least partially dissolve or solvate. In one aspect, the first test voltage E1 may be a value relatively close to the redox potential of the mediator so that a relatively small amount of a reduction or oxidation current is measured. FIG. 7B shows that a relatively small amount of current is observed during the first time interval t₁ compared to the second and third time intervals t₂ and t₃. For example, when using ferricyanide and/or ferrocyanide as the mediator, the first test voltage E1 in FIG. 7A may range from about 1 mV to about 100 mV, preferably range from about 5 mV to about 50 mV, and most preferably range from about 10 mV to about 30 mV. Although the applied voltages are given as positive values in the preferred embodiments, the same voltages in the negative domain could also be used. During this interval, the first current output may be sampled by the processor to collect current values over this interval in step 604.

In exemplary step 606, after applying the first test voltage E1 (step 602) and sampling the output (step 604), the test meter 10 applies a second test voltage E2 between first electrode 166 and second electrode 164 (e.g., approximately 300 mVolts in FIG. 7A), for a second time interval t₂ (e.g., about 3 seconds in FIG. 7A). The second test voltage E2 may be a value different than the first test voltage E1 and may be sufficiently negative of the mediator redox potential so that a limiting oxidation current is measured at the second electrode 164. For example, when using ferricyanide and/or ferrocyanide as the mediator, the second test voltage E2 may range from about zero mV to about 600 mV, preferably range from about 100 mV to about 600 mV, and more preferably is about 300 mV.

The second time interval t₂ should be sufficiently long so that the rate of generation of reduced mediator (e.g., ferrocyanide) may be monitored based on the magnitude of a limiting oxidation current. Reduced mediator is generated by enzymatic reactions with the reagent layer 72. During the second time interval t₂, a limiting amount of reduced mediator is oxidized at second electrode 164 and a non-limiting amount of oxidized mediator is reduced at first electrode 166 to form a concentration gradient between first electrode 166 and second electrode 164.

In an exemplary embodiment, the second time interval t₂ should also be sufficiently long so that a sufficient amount of ferricyanide may be diffused to the second electrode 164 or diffused from the reagent on the first electrode 166. A sufficient amount of ferricyanide is required at the second electrode 164 so that a limiting current may be measured for oxidizing ferrocyanide at the first electrode 166 during the third test voltage E3. The second time interval t₂ may be less than about 60 seconds, and preferably may range from about 1.1 seconds to about 10 seconds, and more preferably range from about 2 seconds to about 5 seconds. Likewise, the time interval indicated as t_{cap} in FIG. 7A may also last over a range of times, but in one exemplary embodiment it has a duration of about 20 milliseconds. In one exemplary embodiment, the superimposed alternating test voltage component is applied after about 0.3 seconds to about 0.4 seconds after the application of the second test voltage E2, and induces a sine wave having a frequency of about 109 Hz with an amplitude of about +/−50 mV. During this interval, a second current output may be sampled by the processor to collect current values over this interval in step 608.

FIG. 7B shows a relatively small peak i_{pb} after the beginning of the second time interval t₂ followed by a gradual increase of an absolute value of an oxidation current during the second time interval t₂. The small peak i_{pb} occurs due oxidation of endogenous or exogenous reducing agents (e.g., uric acid) after a transition from first voltage E1 to second voltage E2. Thereafter, there is a gradual absolute decrease in oxidation current after the small peak i_{pb} is caused by the generation of ferrocyanide by reagent layer 72, which then diffuses to second electrode 164.

In exemplary step 610, after applying the second test voltage E2 (step 606) and sampling the output (step 608), the test meter 10 applies a third test voltage E3 between the first electrode 166 and the second electrode 164 (e.g., about −300 mVolts in FIG. 7A) for a third time interval t₃ (e.g., 1 second in FIG. 7A). The third test voltage E3 may be a value sufficiently positive of the mediator redox potential so that a limiting oxidation current is measured at the first electrode 166. For example, when using ferricyanide and/or ferrocyanide as the mediator, the third test voltage E3 may range from about zero mV to about −600 mV, preferably range from about −100 mV to about −600 mV, and more preferably is about −300 mV.

The third time interval t₃ may be sufficiently long to monitor the diffusion of reduced mediator (e.g., ferrocyanide) near the first electrode 166 based on the magnitude of the oxidation current. During the third time interval t₃, a limiting amount of reduced mediator is oxidized at first electrode 166 and a non-limiting amount of oxidized mediator is reduced at the second electrode 164. The third time interval t₃ may range from about 0.1 seconds to about 5 seconds and preferably range from about 0.3 seconds to about 3 seconds, and more preferably range from about 0.5 seconds to about 2 seconds.

FIG. 7B shows a relatively large peak i_{pc} at the beginning of the third time interval t₃ followed by a decrease to a steady-state current iₛₛ value. In one embodiment, the second test voltage E2 may have a first polarity and the third test voltage E3 may have a second polarity that is opposite to the first polarity. In another embodiment, the second test voltage E2 may be sufficiently negative of the mediator redox potential and the third test voltage E3 may be sufficiently positive of the mediator redox potential. The third test voltage E3 may be applied immediately after the second test voltage E2. However, one skilled in the art will appreciate that the magnitude and polarity of the second and third test voltages may be chosen depending on the manner in which analyte concentration is determined.

Next, glucose concentration calculations will be set forth. FIGS. 7A and 7B show the sequence of events in, e.g., with respect to a test strip transient. At approximately 1.1 second after initiation of the test sequence (and shortly after making the second electrode layer (64) electrode 164 the working electrode due to application of the second voltage E₂), when no reagent has yet reached the first electrode 166, and current is due presumably to only interfering reducing agents in plasma (in the absence of mediator), a current measurement is taken to later correct for interferences. Between about 1.4 seconds and about 4 seconds, when (at least in the latter part of this interval when a second test voltage E₂ is applied) mediator and oxidized mediator have been able to diffuse to the second electrode 164, a first glucose-proportional current, iₗ, is measured. Shortly after making the first electrode the working electrode via application of the third voltage E₃, (2) two single-point measurements (at approximately 4.1 and 5 seconds, according to this embodiment) and one integrated measurement iᵣ are taken. The measurements sampled respectively at 1.1 seconds, 4.1 seconds, and 5 seconds are used to calculate a corrected current i_{2corr}, which may be viewed as partially correcting iᵣ for additive current from interfering reducing agents. The calculation is:

$${i}_{2 corr} = \frac{\vert i ( 4.1 s ) \vert + c \vert i ( 5 s ) \vert - d \vert i ( 1.1 s ) \vert}{\vert i ( 4.1 s ) \vert + c \vert i ( 5 s ) \vert} \cdot {i}_{r}$$

For instance, the i_{2corr} function should tend to unity if no interfering substances (such as Uric acid) are present in the blood. In such a case, the current measurement at 1.1 seconds i(1.1), which measures current, e.g., at the gold electrode, before any diffusing reaction products may reach the top of the test chamber, should be close to zero. In such a case i_{2corr} would mathematically simplify to iᵣ. The i_{2corr} function should also tend to zero if there is no glucose present in the sample—otherwise iᵣ would register a non-glucose signal from interferents alone. This scaling to zero relies in the remaining terms tending to zero in the absence of glucose. This is possible if i(4.1)+ci(5)=di(1.1) when no glucose is present.

In a basic correction algorithm, the ratio of iₗ to iᵣ can be used to correct i2corr for the effects of hematocrit without correcting for an interferent. In such a case, a basic glucose concentration may be calculated as:

$${G}_{basic} = {( \vert \frac{{i}_{r}}{{i}_{l}} \vert )}^{p} \cdot ( a \cdot \vert {i}_{2 corr} \vert - {z}_{gr} ) ,$$

where a, zgr, and p are calibration parameters, where p modifies the hematocrit correcting ratio, and a and zgr modify the slope and intercept, respectively.

However, in G_{basic}, the ratio term itself does not correct for the interferent at all, and the only correction for interferent is found in the calculation of i_{2corr}. But, since iₗ is the sum of all current at the gold electrode from 1.4 to 4 seconds and iᵣ from 4.4 to 5 seconds, they will contain a sizeable component of uric acid (or other non-glucose interferent) generated current.

One way to compensate for this lack of interferent correction in G_{basic} is to subtract out a measure of the steady state interferent current by looking at the signal between about 2.2 to 2.5 seconds. In such a case, e.g., at t=2.2 seconds, very little glucose generated ferrocyanide may have reached the gold electrode and a uric acid concentration gradient has developed extending back from the gold electrode.

As described in the experimental validation section below, the following equation may be used to more precisely correct for the interferent:

$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$

where:
G is the analyte concentration;
iᵣ is the sum of the first current values;
iₗ is the sum of the second current values;
i(δ) is one of the first current values;
i_{2corr} is a function of iᵣ and at least some of the first and second current values; and
u, v, a, and z_{gr} are predetermined coefficients.

In this equation, one way of interpreting the terms is as follows. The term iᵣ−u·i(δ) is representative of a cumulative measure of the interferent effect on the current transient between about 1.4 and 4 seconds, prior to the influence of reaction products of the reagent and the analyte reaching the gold electrode. The term iₗ−v·i(δ) is representative of a cumulative measure of the interferent effect on the current transient between about 4.4 and 5 seconds, which mixes the currents from the interferent and the reaction products. In one representative embodiment, u may be set equal to zero to “turn off” this correction factor.

In one specific working example, the parameters may be selected as set forth in Table 1:

| Parameter | Value |
|---|---|
| a | 0.13 |
| p | 0.568 |
| zgr | 6 |
| c | 0.678 |
| d | 1 |
| u | 0 |
| v | 30 |
| δ | 2.2 |

### Experimental Validation

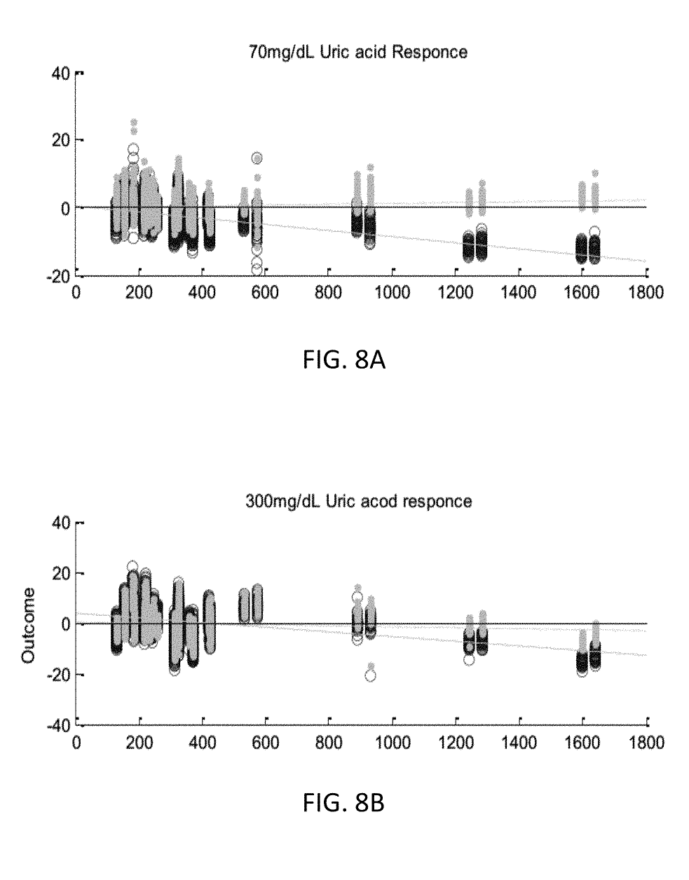

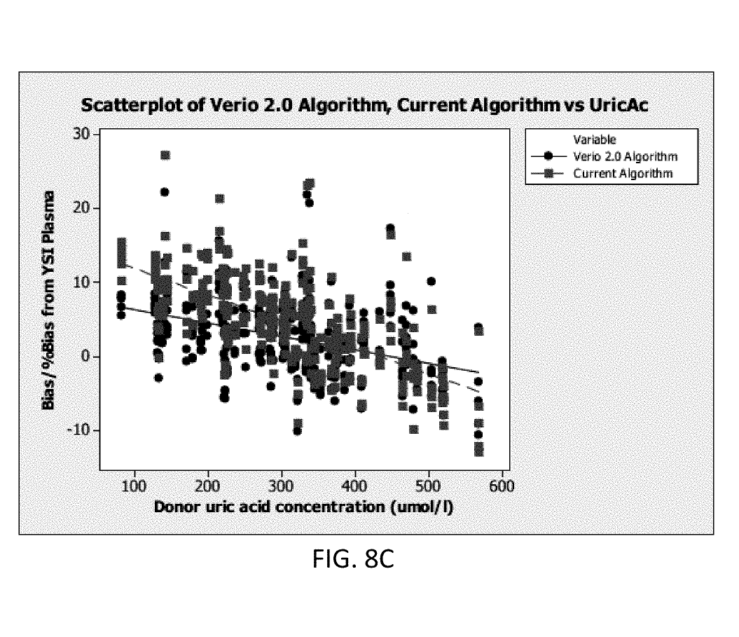

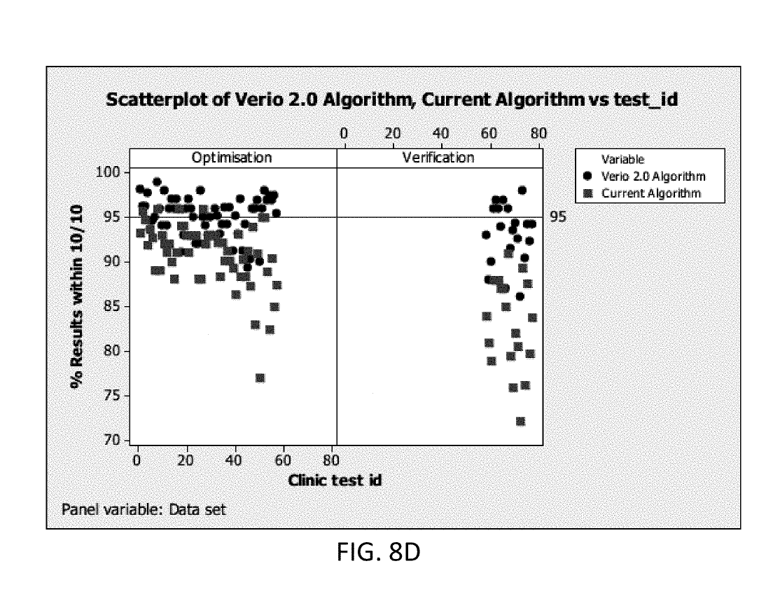

Turning next to FIGS. 8A-8E, an experimental validation was performed to compare the present methods with conventional methods to quantify the improvement to the field of glucose measurement technologies provided by the present techniques.

FIGS. 8A-8D compare the present technique with a technique which is more specifically described in Applicant's U.S. Pat. No. 8,709,232 B2, herein incorporated by reference in its entirety. The presented graphs depict the use of a controlled physiological fluid having a known analyte (glucose) concentration, showing the error or bias that is caused by an increasing interferent (uric acid) concentration. The light grey data points are derived using the present technique, while the dark grey data points are derived using the conventional technique set forth in U.S. Pat. No. 8,709,232 B2. Further background information is also described in Applicant's U.S. patent application Ser. No. 13/824,308, herein incorporated by reference in its entirety.

Turning first to FIG. 8A, with a known analyte concentration of 70 mg/dL, the present technique has very little deviation, represented by the cluster of gray data points near the zero bias line, even as interferent concentration ramps from 200 to 1800 mmol/L. On the other hand, the conventional technique deviates significantly as uric acid concentration increases, going from a bias or deviation of approximately −10 mg/dL to close to −20 mg/dL.

Turning next to FIG. 8B, the known analyte concentration is set to 300 mg/dL, and the results once again demonstrate the superiority of the present technique over the conventional technique. Notably, in this case, where the analyte concentration is over four times greater than that of FIG. 8A, the bias or deviation at a uric acid concentration of 1800 mmol/L is reduced from approximately −20 mg/dL for the conventional technique to half that amount for the present technique.

Advantageously, the present technique improves significantly over the conventional technique, and can reduce the bias or deviation by approximately 100% for certain ranges of analyte concentration and interferent concentration, as shown in FIG. 8A. In addition, the present technique advantageously improves by between 50-100% over the conventional technique in the example of FIG. 8B.

Turning next to FIG. 8C-8D, the experiments noted above were replicated in clinical trials with patients, so as to validate that the present technique improves the determination of glucose concentrations among a wide population of patients. FIG. 8C represents another graph showing the bias or deviation of the present technique as compared to the conventional technique described above. A best fit line was taken that shows that the present technique has a smaller deviation throughout the range of interferent concentrations. FIG. 8D demonstrates a clinical validation study in which N=2,060 glucose measurements were taken. The study demonstrates that the present technique has good results over 93.1% of the samples, whereas the conventional technique has good results over only 83.2% percent of the samples. Thus, the present technique effects a 9.9% percent improvement in accuracy when compared to conventional methods.

By virtue of the improved techniques described herein and with reference to FIG. 6, a method of determining highly accurate glucose concentration can be obtained by deriving an initial glucose proportional current based on a first current, a second current, and an estimated current from the test cell (steps 602, 604, 606, 608, 610, and 612); calculating an initial glucose proportional current (step 614); formulating a hematocrit compensation factor based on the initial glucose proportional current (step 616); and calculating a glucose concentration from the derived initial glucose proportional current and the hematocrit compensation factor (step 618). Thereafter, the result is displayed to the user (step 620), and the test logic returns to a main routine running in the background. The method specifically may involve inserting the test strip into a strip port connector of the test meter to connect at least two electrodes of the test strip to a strip measurement circuit; initiating a test sequence after deposition of a sample; applying a first voltage; initiating a change of analytes in the sample from one form to a different form and switching to a second voltage different than the first voltage; changing the second voltage to a third voltage different from the second voltage; measuring a second current output of the current transient from the electrodes after the changing from the second voltage to the third voltage; estimating a current that approximates a steady state current output of the current transient after the third voltage is maintained at the electrodes; calculating a blood glucose concentration based on the first, second and third current output of the current transient using the equation set forth above.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof “At least one of element A, element B, and element C” is not intended to be limited to at least one of an element A, at least one of an element B, and at least one of an element C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method for determining a concentration of an analyte in a physiological fluid with a biosensor having a first electrode and a second electrode, the physiological fluid comprising the analyte and an interferent, and the method comprising:
applying a voltage between the first electrode and the second electrode of the biosensor, wherein the first electrode comprises a reagent and the second electrode is uncoated with the reagent, the reagent being selected for a reaction with the analyte but not with the interferent;
measuring first current values at the second electrode during a first time period after application of the voltage signal, the first time period being an early stage of the reaction of the reagent with the analyte;
measuring second current values at the first uncoated electrode during a second time period after application of the voltage signal, the second time period being a later stage of the reaction of the reagent with the analyte; and
calculating the analyte concentration, the calculating comprising:
determining a first current parameter by taking the sum of the first current values and subtracting a first factor dependent on at least one of the first current values;
determining a second current parameter by taking the sum of the second current values and subtracting a second factor dependent on the at least one of the first current values; and
determining the analyte concentration as a function of a ratio of the first current parameter and the second current parameter.

2. The method of claim 1, wherein calculating the analyte concentration comprises using an equation of the form
$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$
wherein:
G is the analyte concentration;
iᵣ is the sum of the first current values;
iₗ is the sum of the second current values;
i(δ) is one of the first current values;
i_{2corr} is a function of iᵣ and at least some of the first and second current values; and
u, v, a, and z_{gr} are predetermined coefficients.

3. The method of claim 2, wherein i_{2corr} is determined by an equation of the form
$${i}_{2 corr} = \frac{\vert i ( 4.1 s ) \vert + c \vert i ( 5 s ) \vert - d \vert i ( 1.1 s ) \vert}{\vert i ( 4.1 s ) \vert + c \vert i ( 5 s ) \vert} \cdot {i}_{r} .$$

4. The method of claim 2, wherein the predetermined coefficients are determined using a control fluid having a controlled concentration of the analyte and the interferent.

5. The method of claim 1, wherein the first time period begins about 1.1 seconds after initiating the method.

6. The method of claim 1, wherein the first time period comprises between about 1.4 seconds and 4 seconds after initiating the method.

7. The method of claim 1, wherein the second time period begins about 4.1 seconds after initiating the method.

8. The method of claim 1, wherein the second time period comprises between about 4.4 seconds and 5 seconds after initiating the method.

9. The method of claim 1, further comprising measuring at least one steady state current value during a third time period after application of the voltage signal.

10. The method of claim 9, wherein the third time period begins about 5 seconds after initiating the method.

11. The method of claim 1, further comprising delaying application of the voltage for a time interval after the physiological fluid contacts the biosensor.

12. The method of claim 1, wherein the analyte comprises glucose and the interferent comprises uric acid.

13. The method of claim 1, wherein the interferent comprises a first interferent species and a second interferent species.

14. The method of claim 1, wherein applying the voltage comprises applying a first voltage for a first time interval and applying a second voltage for a second time interval, wherein the first voltage and the second voltage have opposite polarities.

15. The method of claim 1, wherein applying the voltage comprises applying a direct current voltage for a predetermined time interval.

16. The method of claim 1, wherein applying the voltage comprises applying an alternating current voltage for a predetermined time interval.

17. The method of claim 1, wherein the voltage comprises a direct current component and an alternating current component.

18. A glucose measurement system comprising:
a biosensor having a first electrode and a second electrode, the first electrode comprising a reagent and the second electrode being uncoated with the reagent, the reagent being selected for a reaction with glucose but not with an interferent;
a glucose meter configured to connect to the first electrode and the second electrode and comprising a microcontroller programmed to determine a glucose concentration by:
applying a voltage between the first electrode and the second electrode of the biosensor,
measuring first current values at the second electrode during a first time period after application of the voltage signal, the first time period being an early stage of the reaction of the reagent with the glucose,
measuring second current values at the first uncoated electrode during a second time period after application of the voltage signal, the second time period being a later stage of the reaction of the reagent with the analyte, and
calculating the analyte concentration using an equation of the form
$$G = {( \vert \frac{{i}_{r} - u \cdot i ( δ )}{{i}_{l} - v \cdot i ( δ )} \vert )}^{p} \cdot ( a \cdot \vert {i}_{2 corr} \vert - {z}_{gr} ) ,$$
wherein
G is the analyte concentration,
iᵣ is the sum of the first current values,
iₗ is the sum of the second current values,
i(δ) is one of the first current values,
i_{2corr} is a function of iᵣ and at least some of the first and second current values, and
u, v, a, and z_{gr} are predetermined coefficients.

19. The method of claim 18, wherein i_{2corr} is determined by an equation of the form
$${i}_{2 corr} = \frac{\vert i ( 4.1 s ) \vert + c \vert i ( 5 s ) \vert - d \vert i ( 1.1 s ) \vert}{\vert i ( 4.1 s ) \vert + c \vert i ( 5 s ) \vert} \cdot {i}_{r} .$$
